(19) United States
(12) Patent Application Publication
(10) Pub. No.: US 2018/0298644 A1
(43) Pub. Date: Oct. 18, 2018

(54) Blocking Device and System for Mechanical Lock

(71) Applicant: Andre John Vornbrock, Hillsborough, NC (US)

(72) Inventor: Andre John Vornbrock, Hillsborough, NC (US)

(21) Appl. No.: 15/944,773

(22) Filed: Apr. 3, 2018

Related U.S. Application Data
(60) Provisional application No. 62/486,075, filed on Apr. 17, 2017.

(51) Int. Cl. E05B 47/00; E05B 17/04

(52) U.S. Cl. CPC E05B 47/0044; E05B 27/0021; E05B 17/047; E05B 47/0042

(57) ABSTRACT

Blocking devices to stop movement of mechanical or magnetic coded rotors, pins or discs immediately when the plug is turned.

### BACKGROUND OF THE INVENTION

This invention relates generally to an arresting control device and more particularly it relates to a control device for a mechanical or magnetic cylinder lock having a stationary cylindrical housing and a rotatable plug arranged in the housing with a specialized blocking system.

Other locks fail to protect their coded locking system from manipulation and picking based attacks.

### SUMMARY OF THE INVENTION

The primary object of this invention is to provide an improved control device which permits the actuation of the plug in a lock with a mechanical or magnetically coded key, whereby the decoding of the lock is rendered more difficult.

In keeping with this object is the addition of a blocking device to stop movement of mechanical or magnetic coded rotors, pins or discs immediately when the plug is turned. This novel addition prevents direct manipulation of the rotors/pins/discs with the intention that the lock can only be opened by an authorized key.

The blocking system is comprised of several bars that retract and press against the coded rotary or axial members. When engaged the coded rotor gate positions are fixed and no movement of them is possible. In other locks, this movement can be used to decode the position of a gate by testing to see if it moves or is binding. The blocking system ensures that all rotors/pins/discs are held tight and no such information can be gathered on the lock.

### BRIEF DESCRIPTION OF THE DRAWINGS

FIG. 1 is an exploded perspective view example of a lock of the present invention;

FIG. 2 is a cross-sectional front view of a part of the lock according to FIG. 1;

FIG. 3 is a cross-sectional side view of a part of the lock according to FIG. 1;

FIG. 4 is a cross-sectional top view of a part of the lock according to FIG. 1;

### DETAILED DESCRIPTION OF THE INVENTION

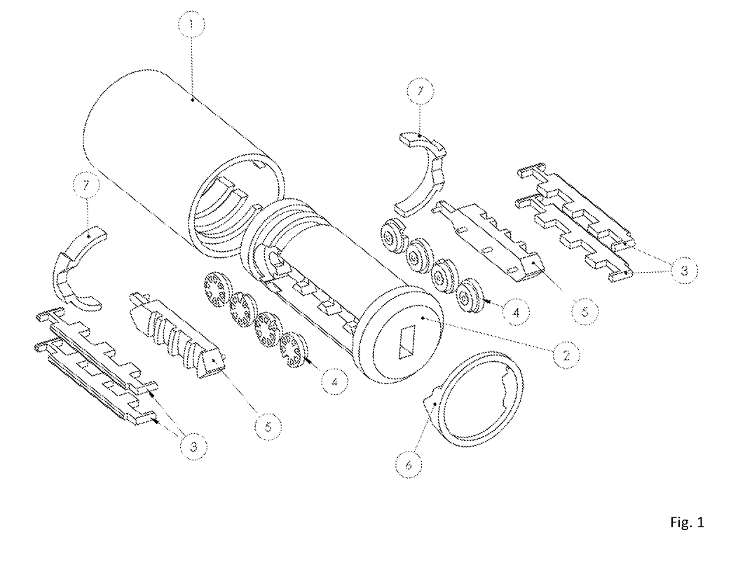

Referring now to the invention in more detail, FIG. 1 shows parts of a cylinder lock according to the invention. The control device of this invention includes a stationary housing 1 defining a cylindrical passage in which a cylindrical plug 2 is arranged for rotation about its center axis. Plug 2 defines a central key channel into which a magnetically coded key is insertable from the front.

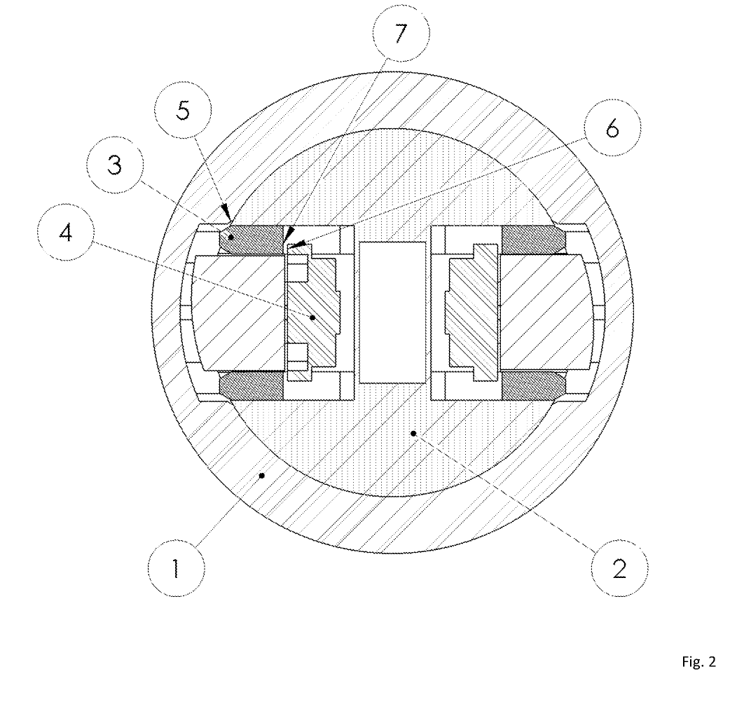

FIG. 2 shows a cross-sectional view from the front of the lock. Rotor blocking bar 3 is positioned so that when the core 2 is rotated respective to the housing 1 slightly, it will contact Point 5 and retract towards the center of the plug 2 until Point 7 touches rotary members 4 at point 6 preventing their movement entirely.

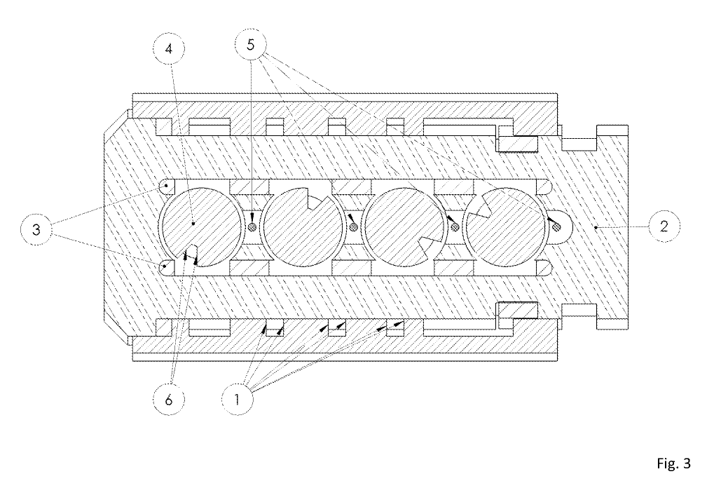

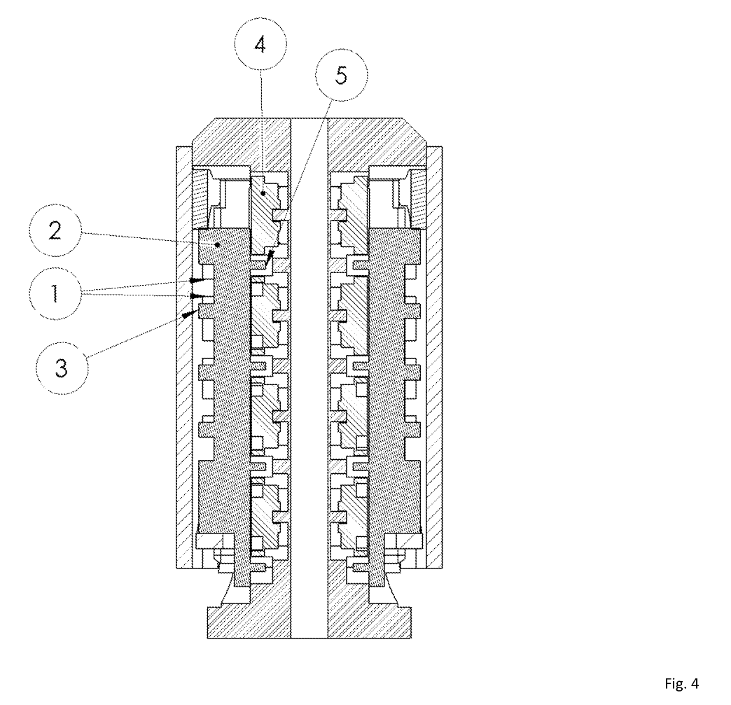

If rotation continues sidebar 2 in FIG. 4 will begin to travel up until pins 5 meet rotary members 4. If all pins 5 encounter correct gates 6 in FIG. 3, the sidebar 2 in FIG. 4 can continue travel forward until it is in the unlocked position. The unlocked position is determined by milling in the sidebar 3 in FIG. 4 to match up with counter-milling in the housing 1.

If any pin 5 does not encounter their respective correct gates 6 in FIG. 3, the sidebar 2 will not move and will arrest further movement of the plug 2. At this time a manipulation or picking attack cannot be successfully completed as the rotary members 4 are not movable. As the rotor members 4 are totally arrested in movement, no information of their position can be obtained either.

FIG. 3 shows the correct blocking bar channels 3 for the rotor blocking bar 3 in FIG. 1.

A key comprising of a coding to match rotors 4 in FIG. 1 would enter hole in the front of plug 2 to manipulate rotors 4 into their correct position. Upon turning said key, the blocking system would then engage to prevent any further rotor 4 movement. Sidebar 5 would then travel longitudinally forward until in the axial unlocked position relative to housing 1 and the plug 2 could rotate freely 360 degrees.

I claim:

1. A control device, particularly for use in a mechanical or magnetic cylinder lock, comprising,
a. a housing defining a cylindrical passage;
b. a cylindrical plug that fits into said passage for rotational movement relative to said housing;
c. a keyhole through the front end of said plug;
d. a means between said plug and said housing for blocking the rotational movement in one axial position of said plug and for unblocking the rotational movement in another axial position thereof;
e. said plug having at least one longitudinal groove and a multiple of rotary members each supported for rotation about an axis transverse to said longitudinal groove; and
f. blocking bars extending in longitudinal direction between said plug and said sleeve and to stop said rotary members movement immediately when cylindrical plug is rotated in said housing.
A blocking system to stop movement of mechanical or magnetic coded rotors, pins or discs comprising,
a. rotary members mechanically or magnetically coded;
b. at least one bar that will arrest rotational movement when in one axial position and allow it in another axial position;
c. a key matching said mechanical or magnetic coding; and
d. at least one blocking bar that will arrest rotor, pin or disc movement.
